(19) United States
(12) Patent Application Publication
(10) Pub. No.: US 2015/0137409 A1
(43) Pub. Date: May 21, 2015

(54) Method For Forming Textile Article

(71) Applicant: Hsien-Hsiao HSIEH, Changhua City (TW)

(72) Inventor: Hsien-Hsiao HSIEH, Changhua City (TW)

(21) Appl. No.: 14/086,061

(22) Filed: Nov. 21, 2013

(51) Int. Cl. B29C 51/00

(52) U.S. Cl. CPC B29C 51/004; B29K 2105/256
USPC 264/103

(57) ABSTRACT

A method for forming a textile article includes the steps of providing at least one shaping yarn and at least one basic yarn; processing the shaping yarn and the basic yarn to form a primitive textile structure; fitting the primitive textile structure to a shaping mold; applying high temperature to heat the primitive textile structure so as to have the shaping yarn included in the primitive textile structure heated and molten to form a shaping film covering the basic yarn; applying a low temperature to solidify the shaping film that covers the basic yarn so as to fix a shape of the primitive textile structure to form a shaped textile structure; and removing the shaped textile structure of which the shape is fixed from the shaping mold.

### FIELD OF THE INVENTION

The present invention relates to a method for forming a textile article, and in particular to a method for forming a textile article that enables three-dimensional formation by including a textile having thermoplastic property.

### BACKGROUND OF THE INVENTION

A conventional textile, after having being completely made, is generally a flexible article, which shows no strength for erection and is thus incapable of forming a three-dimensional article. On the other hand, a leather article, such as a shoe and a bag, is generally made by being divided into several individual and separate pieces of leather, which are then sewn or coupled together by other means to form a complete shoe or bag. Such a process requires first applying cutting operations to form those individual and separate pieces of leather according to a design drawing. The larger the number of the individual pieces is, the more the operation steps will be and thus the higher the cost will be.

Thus, it is desired to provide a method for making a textile structure that can be formed as a three-dimensional article, in order to overcome the problem of large number of operation steps and waste of cost.

### SUMMARY OF THE INVENTION

The primary object of the present invention is to provide a method for forming a textile article that uses thermoplastic shaping yarns to form a textile and applying heating to shape the textile to form a three-dimensional article.

To achieve the above object, the present invention provides a method for forming a textile article, comprising the following steps: Step 1: providing at least one shaping yarn and at least one basic yarn; Step 2: processing the shaping yarn and the basic yarn to form a primitive textile structure; Step 3: fitting the primitive textile structure to a shaping mold; Step 4: applying high temperature to heat the primitive textile structure so as to have the shaping yarn included in the primitive textile structure heated and molten to form a shaping film covering the basic yarn; Step 5: applying a low temperature to solidify the shaping film that covers the basic yarn so as to fix a shape of the primitive textile structure to form a shaped textile structure; and Step 6: removing the shaped textile structure of which the shape is fixed from the shaping mold.

According to the above-described method for forming a textile article, the shaping yarn is made of a material comprising a thermoplastic polymer and a property modification agent mixed together.

According to the above-described method for forming a textile article, the thermoplastic polymer comprises polyurethane.

According to the above-described method for forming a textile article, the thermoplastic polymer comprises polyethylene.

According to the above-described method for forming a textile article, the thermoplastic polymer comprises polypropylene.

According to the above-described method for forming a textile article, the thermoplastic polymer comprises a thermoplastic rubber.

According to the above-described method for forming a textile article, the property modification agent comprises an organic resin.

According to the above-described method for forming a textile article, the property modification agent comprises inorganic resin.

According to the above-described method for forming a textile article, the property modification agent comprises silicon oil.

According to the above-described method for forming a textile article, the property modification agent comprises phosphate ester.

According to the above-described method for forming a textile article, the property modification agent comprises phthalic acid.

According to the above-described method for forming a textile article, the property modification agent comprises an antioxidant.

According to the above-described method for forming a textile article, the primitive textile structure is a shoe textile article.

According to the above-described method for forming a textile article, the primitive textile structure is a bag textile article.

According to the above-described method for forming a textile article, the primitive textile structure is a garment textile article.

### BRIEF DESCRIPTION OF THE DRAWINGS

The present invention will be apparent to those skilled in the art by reading the following description of preferred embodiments thereof with reference to the drawings, in which:

FIG. 1 is a flow chart illustrating a method for forming a textile article according to the present invention;

FIG. 2 is a schematic view illustrating a first example of the method for forming a textile article in accordance with the present invention;

FIG. 3 is an enlarged view of a dash-line encircling portion A of FIG. 2;

FIG. 4 is an enlarged view of a dash-line encircling portion BA of FIG. 2;

FIG. 5 is a schematic view illustrating a second example of the method for forming a textile article in accordance with the present invention;

FIG. 6 is a schematic view illustrating a third example of the method for forming a textile article in accordance with the present invention;

FIG. 7 is a schematic view illustrating a fourth example of the method for forming a textile article in accordance with the present invention;

FIG. 8 is an enlarged view of a dash-line encircling portion C of FIG. 7; and

FIG. 9 is an enlarged view of a dash-line encircling portion D of FIG. 7.

### DETAILED DESCRIPTION OF THE PREFERRED EMBODIMENTS

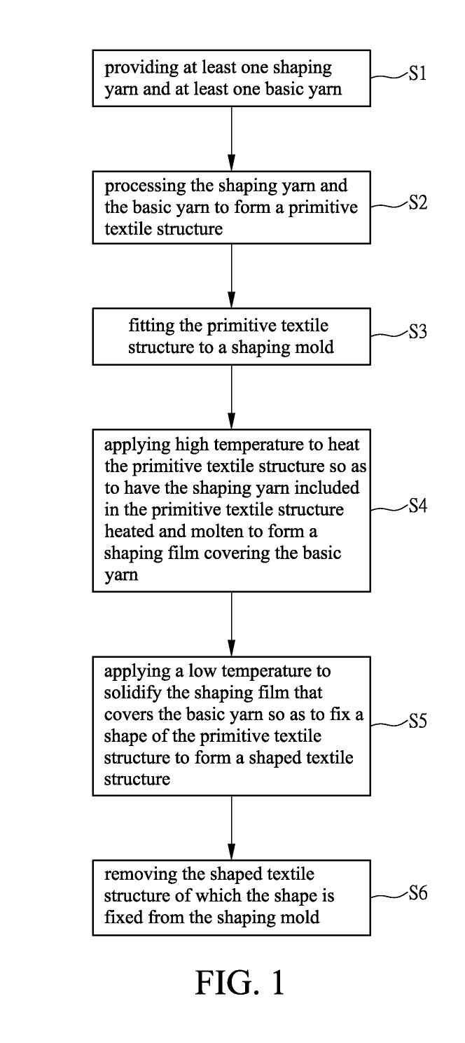

With reference to the drawings and in particular to FIG. 1, which is a flow chart illustrating a method for forming a textile article according to the present invention, as shown in the drawing, the method for forming a textile article according to the present invention comprises the following steps: Step 1 (S1): providing at least one shaping yarn and at least one basic yarn; Step 2 (S2): processing the shaping yarn and the basic yarn to form a primitive textile structure; Step 3 (S3): fitting the primitive textile structure to a shaping mold; Step 4 (S4): applying high temperature to heat the primitive textile structure so as to have the shaping yarn included in the primitive textile structure heated and molten to form a shaping film covering the basic yarn; Step 5 (S5): applying a low temperature to solidify the shaping film that covers the basic yarn so as to fix a shape of the primitive textile structure to form a shaped textile structure; and Step 6 (S6): removing the shaped textile structure of which the shape is fixed from the shaping mold.

In the method for forming a textile article described above, the thermoplastic polymer can be one of polyamide, polyurethane, polyethylene, polypropylene, and thermoplastic rubber. The property modification agent can be one of organic resin, inorganic resin, silicon oil, phosphate ester, phthalic acid, and antioxidant. The property modification agent is provided for modifying the property of the shaping yarn, such as viscosity and heat sensitivity in order to control the melting temperature thereof within a predetermined range. The primitive textile structure can be one of a shoe textile article, a bag textile article, and a garment textile article, depending upon a final product to be made. For example, if the final product to be made is a three-dimensional shoe structure, then the primitive textile structure is formed, through for example knitting, weaving, or other known yarn processing methods, as a shoe textile article corresponding to the three-dimensional shoe structure.

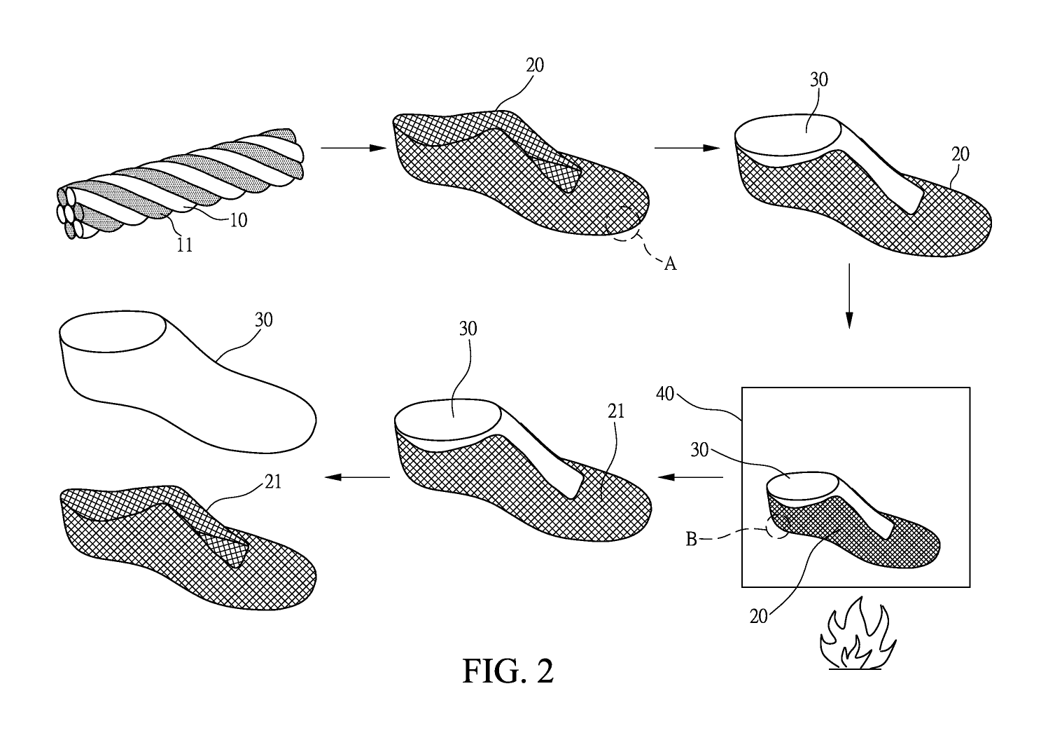

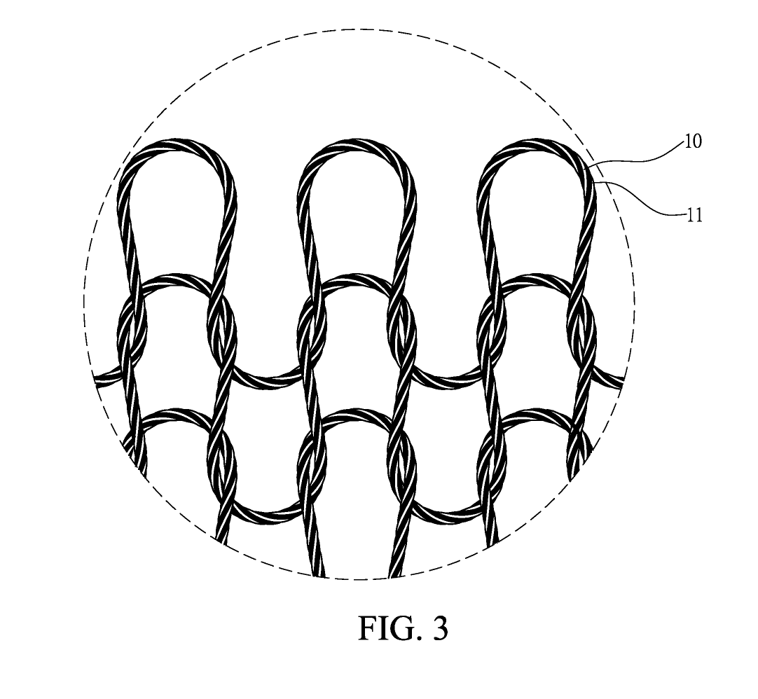

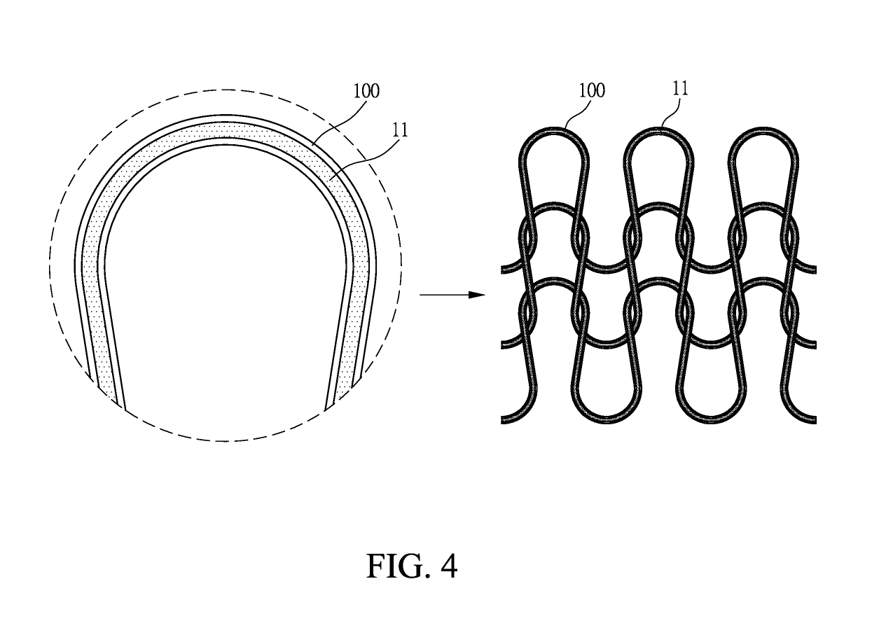

Referring to FIG. 2, which is a schematic view illustrating a first example of the method for forming a textile article in accordance with the present invention, as shown in the drawing, according to the method for forming a textile article of the present invention, Step 1 (S1) is providing a shaping yarn 10 and a basic yarn 11 that are twisted together; Step 2 (S2) is processing, such as knits or weaves, the twisted shaping yarn 10 and basic yarn 11 to form a primitive textile structure 20 (which in the instant example is a three-dimensional structure of a shoe textile article), further illustration being given with reference to FIG. 3, which is an enlarged view of a dash-line encircling portion A of FIG. 2, where, as shown in the drawing, the shaping yarn that is included in the shoe textile article so formed is not yet subjected to heating and is thus of a solid state and is entangled with the basic yarn; Step 3 (S3) is fitting the primitive textile structure 20 to a shaping mold 30 (which is the instant example is a shoe last); Step 4 (S4) is applying a high temperature to heat the primitive textile structure 20, such as an oven 40, the temperature being set at a level higher than 80° C., so that the shaping yarn 10 included in the primitive textile structure 20 is heated and molten to form a shaping film 100 covering the basic yarn 11 (see FIG. 4, which is an enlarged view of a dash-line encircling portion BA of FIG. 2); Step 5 (S5) is applying a low temperature to solidify the shaping film 100 that covers the basic yarn 11 (such as placing the primitive textile structure and the shaping mold in room temperature, meaning a temperature that is lower than the solidification temperature of the shaping yarn 10), so that the shape of the primitive textile structure 20 is fixed to form a shaped textile structure 21; and Step 6 (S6) is removing the shaped textile structure 21 of which the shape is fixed from the shaping mold 30 to obtain a shoe product.

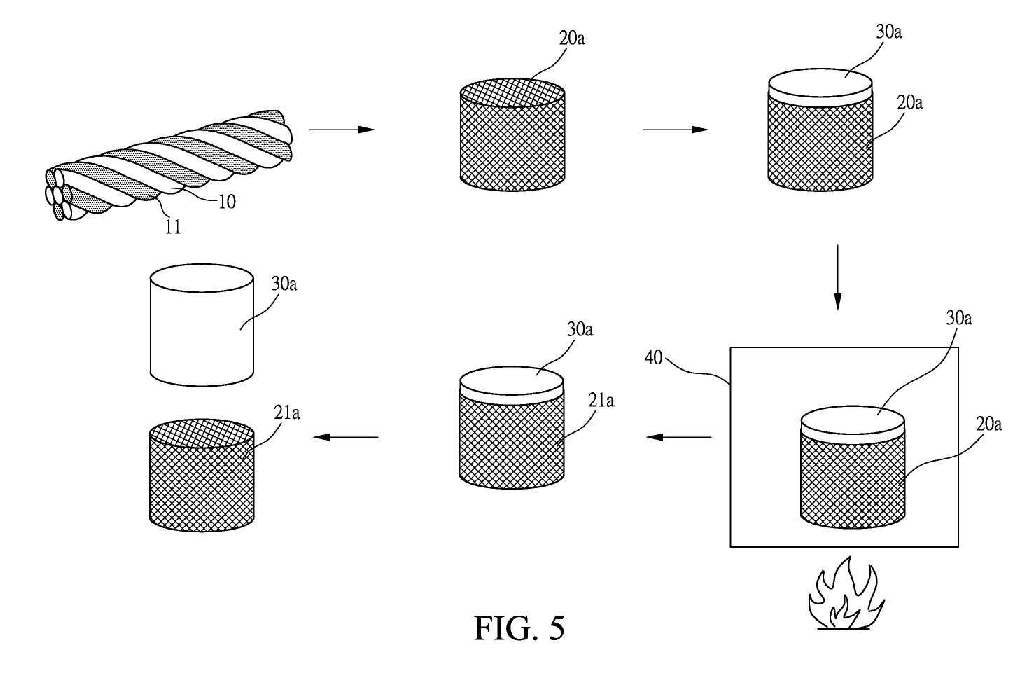

Referring to FIG. 5, which is a schematic view illustrating a second example of the method for forming a textile article in accordance with the present invention, as shown in the drawing, according to the method for forming a textile article of the present invention, Step 1 (S1) is providing a shaping yarn 10 and a basic yarn 11 that are twisted together; Step 2 (S2) is processing, such as knits or weaves, the twisted shaping yarn 10 and basic yarn 11 to form a primitive textile structure 20a (which in the instant example is a bag textile article); Step 3 (S3) is fitting the primitive textile structure 20a to a shaping mold 30a (which in the instant example is a bag mold); Step 4 (S4) is applying a high temperature to heat the primitive textile structure 20a, so that the shaping yarn 10 included in the primitive textile structure 20a is heated and molten to form a shaping film 100 covering the basic yarn 11; Step 5 (S5) is applying a low temperature to solidify the shaping film 100 that covers the basic yarn 11, so that the shape of the primitive textile structure 20a is fixed to form a shaped textile structure 21a (which in the instant example is a bag having a fixed shape); and Step 6 (S6) is removing the shaped textile structure 21a of which the shape is fixed from the shaping mold 30a to obtain a bag product.

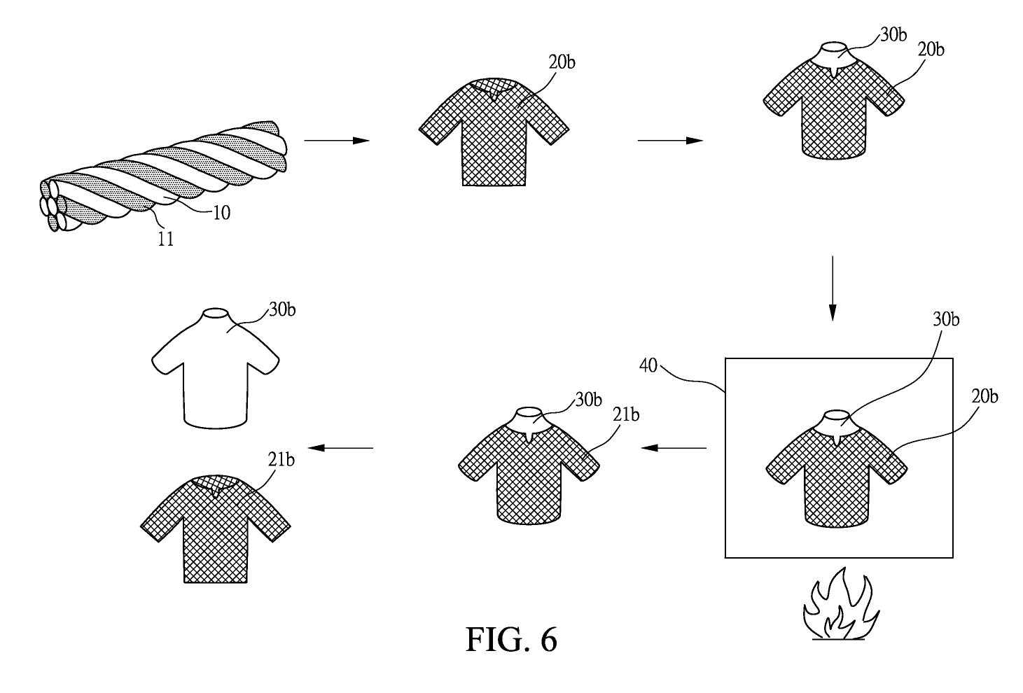

Referring to FIG. 6, which is a schematic view illustrating a third example of the method for forming a textile article in accordance with the present invention, as shown in the drawing, according to the method for forming a textile article of the present invention, Step 1 (S1) is providing a shaping yarn 10 and a basic yarn 11 that are twisted together; Step 2 (S2) is processing, such as knits or weaves, the twisted shaping yarn 10 and basic yarn 11 to form a primitive textile structure 20b (which in the instant example is a garment textile article); Step 3 (S3) is fitting the primitive textile structure 20b to a shaping mold 30b (which in the instant example is a mold of an upper body of human being); Step 4 (S4) is applying a high temperature to heat the primitive textile structure 20b, so that the shaping yarn 10 included in the primitive textile structure 20b is heated and molten to form a shaping film 100 covering the basic yarn 11; Step 5 (S5) is applying a low temperature to solidify the shaping film 100 that covers the basic yarn 11, so that the shape of the primitive textile structure 20b is fixed to form a shaped textile structure 21b (which in the instant example is a garment having a fixed shape); and Step 6 (S6) is removing the shaped textile structure 21b of which the shape is fixed from the shaping mold 30b to obtain a garment product.

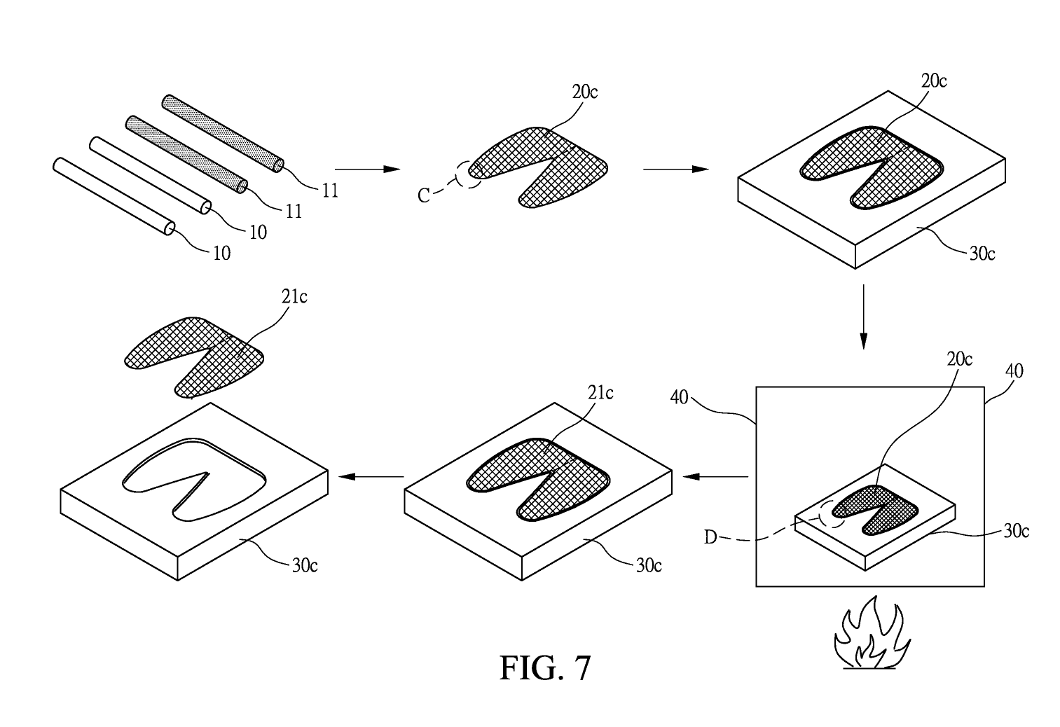

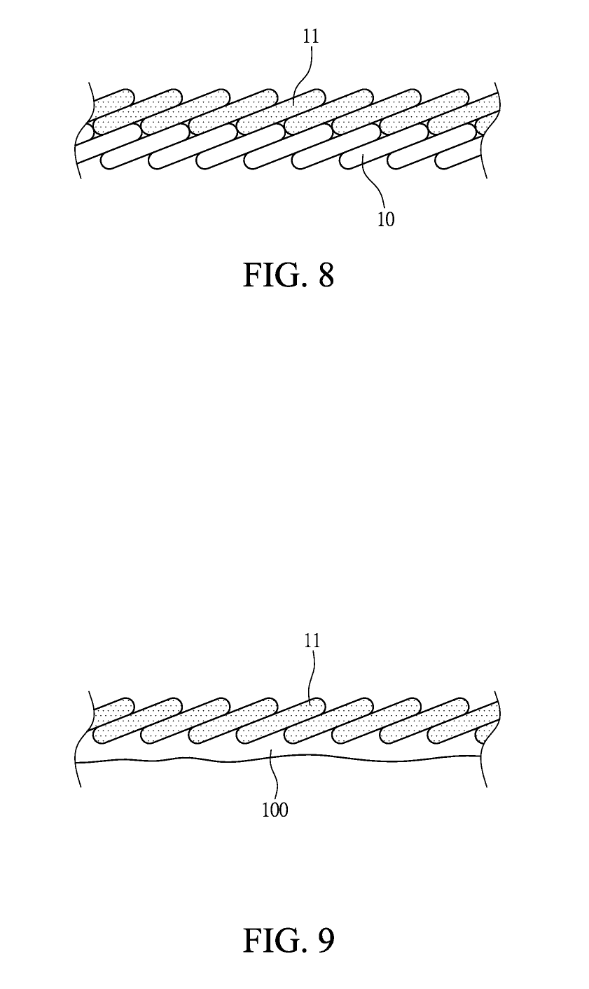

Referring to FIG. 7, is a schematic view illustrating a fourth example of the method for forming a textile article in accordance with the present invention, as shown in the drawing, according to the method for forming a textile article of the present invention, Step 1 (S1) is providing a plurality of shaping yarns 10 and a plurality of basic yarns 11 (where, if desired, adjustment can be made to provide multiple shaping yarns and basic yarns, if a final product needs various colors and to provide a shaping yarn and a basic yarn, if a final product is of single color); Step 2 (S2) is processing, such as knitting or weaving, the shaping yarn 10 and the basic yarns 11 to form a primitive textile structure 20c (which in the instant example is a planar shoe textile article, which can be formed through knitting, plain weaving, and the likes), further illustration being given with reference to FIG. 8, which is an enlarged view of a dash-line encircling portion C of FIG. 7, where, as shown in the drawing, the shaping yarns 10 included in the primitive textile structure 20c so formed (the planar shoe textile article) is not yet subjected to heating and is thus of a solid state and is entangled with the basic yarns 11 in a two-layered (upper and lower layers) arrangement; Step 3 (S3) is fitting the primitive textile structure 20c to a shaping mold 30c (which in the instant example is a planar mold that comprises a mold cavity in which the primitive textile structure 20c is receivable); Step 4 (S4) is applying a high temperature to heat the primitive textile structure 20c, such as an oven 40, the temperature being set at a level higher than 80° C. (the temperature being determined and adjusted according to the properties of the materials of the shaping yarns 10 and the basic yarns 11), so that the shaping yarns 10 included in the primitive textile structure 20c is heated and molten to form a shaping film 100 covering the basic yarns 11, further illustration being given with reference to FIG. 9, which is an enlarged view of a dash-line encircling portion D of FIG. 7, where, as shown in the drawing, due to the way adopted to form the primitive textile structure 20c, the shaping film 100 may be concentrated at one side of the basic yarns 11, which is generally an inner side of a product, this way being also applicable to the above described examples; Step 5 (S5) is applying a low temperature to solidify the shaping film 100 that covers outside the basic yarns 11 (such as placing the primitive textile structure and the shaping mold in room temperature, meaning a temperature that is lower than the solidification temperature of the shaping yarns 10), so that the shape of the primitive textile structure 20c is fixed to form a shaped textile structure 21c; and Step 6 (S6) is removing the shaped textile structure 21c of which the shape is fixed from the shaping mold 30c to obtain a planar shoe product.

In summary, the method for forming a textile article according to the present invention adopts a processing manner, such as knitting or weaving, to form, in an integrated manner, a primitive textile structure that is fit to a shaping mold and heated for shape fixing whereby all the parts can be formed in one operation step so as to save various operation steps. As such, operation time can be saved and cost can be greatly reduced.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A method for forming a textile article, comprising the following steps:
(1) providing at least one shaping yarn and at least one basic yarn;
(2) processing the shaping yarn and the basic yarn to form a primitive textile structure;
(3) fitting the primitive textile structure to a shaping mold;
(4) applying high temperature to heat the primitive textile structure so as to have the shaping yarn included in the primitive textile structure heated and molten to form a shaping film covering the basic yarn;
(5) applying a low temperature to solidify the shaping film that covers the basic yarn so as to fix a shape of the primitive textile structure to form a shaped textile structure; and
(6) removing the shaped textile structure of which the shape is fixed from the shaping mold.

2. The method for forming a textile article as claimed in claim 1, wherein the shaping yarn is made of a material comprising a thermoplastic polymer and a property modification agent mixed together.

3. The method for forming a textile article as claimed in claim 2, wherein the thermoplastic polymer comprises polyamide.

4. The method for forming a textile article as claimed in claim 2, wherein the thermoplastic polymer comprises polyurethane.

5. The method for forming a textile article as claimed in claim 2, wherein the thermoplastic polymer comprises polyethylene.

6. The method for forming a textile article as claimed in claim 2, wherein the thermoplastic polymer comprises polypropylene.

7. The method for forming a textile article as claimed in claim 2, wherein the thermoplastic polymer comprises a thermoplastic rubber.

8. The method for forming a textile article as claimed in claim 2, wherein the property modification agent comprises an organic resin.

9. The method for forming a textile article as claimed in claim 2, wherein the property modification agent comprises inorganic resin.

10. The method for forming a textile article as claimed in claim 2, wherein the property modification agent comprises silicon oil.

11. The method for forming a textile article as claimed in claim 2, wherein the property modification agent comprises phosphate ester.

12. The method for forming a textile article as claimed in claim 2, wherein the property modification agent comprises phthalic acid.

13. The method for forming a textile article as claimed in claim 2, wherein the property modification agent comprises an antioxidant.

14. The method for forming a textile article as claimed in claim 1, wherein the primitive textile structure is a shoe textile article.

15. The method for forming a textile article as claimed in claim 1, wherein the primitive textile structure is a bag textile article.

16. The method for forming a textile article as claimed in claim 1, wherein the primitive textile structure is a garment textile article.
